(19) United States
(12) Patent Application Publication
(10) Pub. No.: US 2023/0049148 A1
(43) Pub. Date: Feb. 16, 2023

(54) FUEL CELL HAVING A COMPLIANT ENERGY ATTENUATING BUMPER

(71) Applicant: GM Global Technology Operations LLC, Detroit, MI (US)

(72) Inventors: Yeh-Hung Lai, Oakland, MI (US); Jeffrey A. Rock, Rochester Hills, MI (US)

(21) Appl. No.: 17/403,031

(22) Filed: Aug. 16, 2021

(51) Int. Cl. H01M 8/0267; H01M 8/0247; H01M 8/0258; H01M 8/0276

(52) U.S. Cl. CPC H01M 8/0267; H01M 8/0247; H01M 8/0258; H01M 8/0276; H01M 2250/20

(57) ABSTRACT

A fuel cell system includes a plurality of stacked bipolar plate assemblies. Each of the plurality of stacked bipolar plate assemblies includes a first subgasket including a first peripheral edge. The first subgasket supports a first membrane electrode assembly (MEA). A second subgasket including a second peripheral edge supports a second MEA. A bipolar plate is disposed between the first subgasket and the second subgasket. The bipolar plate has a first side defining a first plurality of passages receptive of a cathode fluid, a second side defining a second plurality of passages receptive of an anode fluid, and a plurality of coolant passages defined between the first subgasket and the second subgasket. A seal bead extends around the bipolar plate. The seal bead seals against the first subgasket and the second subgasket. A compliant energy attenuating bumper extends about the bipolar plate spaced from the seal bead.

### INTRODUCTION

The subject disclosure relates to the art of fuel cells and, more particularly, to a fuel cell having a compliant energy attenuating bumper.

Fuel cells are used in a variety of vehicles to produce electric energy. The electric energy may be stored in a battery and/or directed to a motor to provide a motive force to the vehicle. In a typical fuel cell, such as a polymer electrolyte membrane fuel cell, an ion-transmissive membrane is sandwiched between a pair of catalyzed electrodes, which are further sandwiched between two gas diffusion layers to form a membrane electrode assembly (MEA). An electrochemical reaction occurs when a first reactant in the form of gaseous reducing agent such as Hydrogen is introduced through a first gas diffusion layer to an anode electrode and ionized. The first reactant is then passed through the ion-transmissive material. After passing through the ion-transmissive material, the first reactant combines with a second reactant in the form of a gaseous oxidizing agent such as oxygen that has been introduced through a second gas diffusion layer to a cathode. The combination of reactants form water. Electrons liberated in the ionization proceed, in the form of DC current, to the cathode via an external circuit that typically includes a load such as an electric motor.

MEAs are typically formed into a stack to form a fuel cell. Adjacent MEA's are separated, one from another, by a series of reactant channels, typically in the form of a gas impermeable bipolar plate. The bipolar plate, in addition to promoting a flow of reactants, also provides support for the stack. Each bipolar plate includes one or more seal beads that prevent reactants from leaving the MEA. During a crash event, leading cells, those cells closest to a point of impact, experience an effective positive acceleration force and trailing cells, those cells farthest from the point of impact, experience an effective negative acceleration force. Thus, the leading cells tend to experience increasing seal force while the trailing cells tend to experience a decreasing seal force.

As the seal force on the leading cells increases, so does the risk of exceeding an upper sealing force limit. Similarly, as the seal force on the trailing seals decreases, so does the risk of falling below a minimum seal force. Exceeding the upper limit or falling below the lower limit of the seal forces can cause seal beads to deform. Deformation of the seal bead impacts the integrity of each cell and could lead to leakage of the first reactant, the second reactant and/or coolant. Accordingly, it is desirable to provide a fuel cell with an energy attenuating bumper to improve structural integrity and impact resistance.

### SUMMARY

Disclosed is a fuel cell system including a plurality of stacked bipolar plate assemblies. Each of the plurality of stacked bipolar plate assemblies includes a first subgasket including a first peripheral edge. The first subgasket supports a first membrane electrode assembly (MEA). A second subgasket including a second peripheral edge supports a second MEA. A bipolar plate is disposed between the first subgasket and the second subgasket. The bipolar plate has a first side defining a first plurality of passages receptive of a cathode fluid, a second side defining a second plurality of passages receptive of an anode fluid, and a plurality of coolant passages defined between the first subgasket and the second subgasket. A seal bead extends around the bipolar plate. The seal bead seals against the first subgasket and the second subgasket. A compliant energy attenuating bumper extends about the bipolar plate spaced from the seal bead.

In addition to one or more of the features described herein the compliant energy attenuating bumper includes a first compliant bumper element and a second compliant bumper element.

In addition to one or more of the features described herein the first compliant bumper element comprises a first polymer pad and the second compliant bumper element comprises a second polymer pad.

In addition to one or more of the features described herein the first compliant bumper element includes a first stiffness and the second compliant bumper element includes a second stiffness.

In addition to one or more of the features described herein the first stiffness of the first compliant bumper element matches the second stiffness of the second compliant bumper element.

In addition to one or more of the features described herein the seal bead includes a first stiffness and the compliant energy attenuating bumper includes a second stiffness that is distinct from the first stiffness.

In addition to one or more of the features described herein the second stiffness is between about one half that of the first stiffness and about 10 times greater than the first stiffness.

In addition to one or more of the features described herein the bipolar plate is formed from one of a metal and a non-metal.

Also disclosed is a power system including an electric motor and a fuel cell system including a plurality of stacked bipolar plate assemblies. Each of the plurality of stacked bipolar plate assemblies includes a first subgasket including a first peripheral edge. The first subgasket supports a first membrane electrode assembly (MEA). A second subgasket including a second peripheral edge supports a second MEA. A bipolar plate is disposed between the first subgasket and the second subgasket. The bipolar plate has a first side defining a first plurality of passages receptive of a cathode fluid, a second side defining a second plurality of passages receptive of an anode fluid, and a plurality of coolant passages defined between the first subgasket and the second subgasket. A seal bead extends around the bipolar plate. The seal bead sealing against the first subgasket and the second subgasket. A compliant energy attenuating bumper extends about the bipolar plate spaced from the seal bead.

In addition to one or more of the features described herein the compliant energy attenuating bumper includes a first compliant bumper element and a second compliant bumper element.

In addition to one or more of the features described herein the first compliant bumper element comprises a first polymer pad and the second compliant bumper element comprises a second polymer pad.

In addition to one or more of the features described herein the first compliant bumper element includes a first stiffness and the second compliant bumper element includes a second stiffness.

In addition to one or more of the features described herein the first stiffness of the first compliant bumper element matches the second stiffness of the second compliant bumper element.

In addition to one or more of the features described herein the seal bead includes a first stiffness and the compliant energy attenuating bumper includes a second stiffness that is distinct from the first stiffness.

Further disclosed is a vehicle including a body, and a power system arranged in the body. The power system includes an electric motor and a fuel cell system including a plurality of stacked bipolar plate assemblies. Each of the plurality of stacked bipolar plate assemblies includes a first subgasket including a first peripheral edge. The first subgasket supports a first membrane electrode assembly (MEA). A second subgasket including a second peripheral edge supports a second MEA. A bipolar plate is disposed between the first subgasket and the second subgasket. The bipolar plate has a first side defining a first plurality of passages receptive of a cathode fluid, a second side defining a second plurality of passages receptive of an anode fluid, and a plurality of coolant passages defined between the first subgasket and the second subgasket. A seal bead extends around the bipolar plate. The seal bead sealing against the first subgasket and the second subgasket. A compliant energy attenuating bumper extends about the bipolar plate spaced from the seal bead.

In addition to one or more of the features described herein the compliant energy attenuating bumper includes a first compliant bumper element and a second compliant bumper element.

In addition to one or more of the features described herein the first compliant bumper element comprises a first polymer pad and the second compliant bumper element comprises a second polymer pad.

In addition to one or more of the features described herein the first compliant bumper element includes a first stiffness and the second compliant bumper element includes a second stiffness.

In addition to one or more of the features described herein the first stiffness of the first compliant bumper element matches the second stiffness of the second compliant bumper element.

In addition to one or more of the features described herein the seal bead includes a first stiffness and the compliant energy attenuating bumper includes a second stiffness that is distinct from the first stiffness.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a vehicle including a power system having a fuel cell system with a plurality of stacked bipolar plate assemblies each having a compliant energy attenuating bumper, in accordance with a non-limiting example;

FIG. 2 is a block diagram depicting the power system of FIG. 1, in accordance with a non-limiting example;

FIG. 3 depicts the stacked bipolar plate assemblies of the fuel cell system of FIG. 1, in accordance with a non-limiting example;

FIG. 4 is a partially disassembled view of one of the stacked bipolar plate assemblies in FIG. 3; and

FIG. 5 depicts a partial top down cross-sectional view of the bipolar plate assemblies of FIG. 3 taken along the line 4-4, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

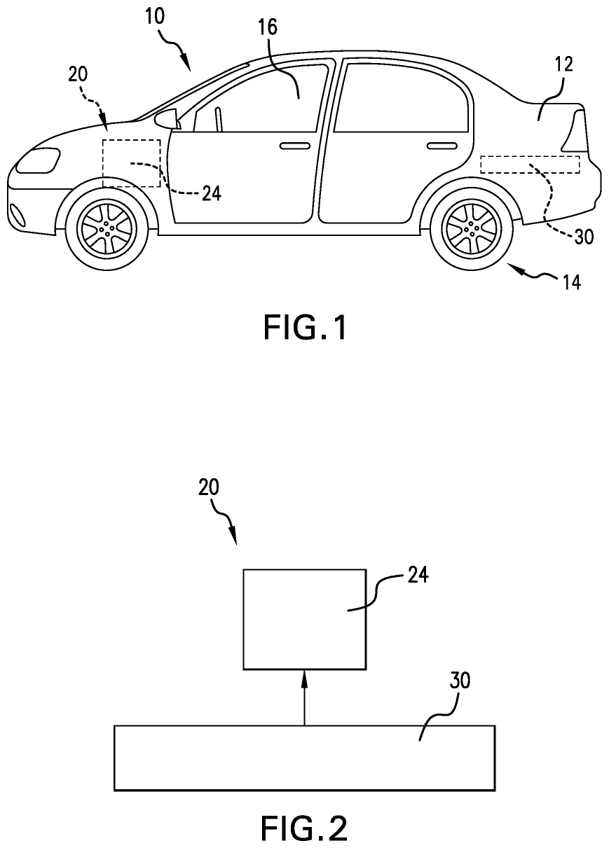

A vehicle, in accordance with a non-limiting example, is indicated generally at 10 in FIG. 1. Vehicle 10 includes a body 12 resting on a plurality of wheels, one of which is indicated at 14. Vehicle 10 includes a passenger compartment 16. A power system 20 is operatively connected to one or more of the plurality of wheels 14. Referring to FIG. 2, power system 20 includes an electric motor 24 connected to a fuel cell system 30. Fuel cell system 30 provides electric power to operate electric motor 24 based on driver inputs. That is, a driver (not shown) seated in passenger compartment 16 may request power be delivered to wheels 14 from electric motor 24. At this point, it should be understood that while vehicle 10 is depicted as an automobile, in accordance with non-limiting examples, fuel cell system 30 may be employed in a variety of vehicles including locomotives, airplanes, ships, and the like.

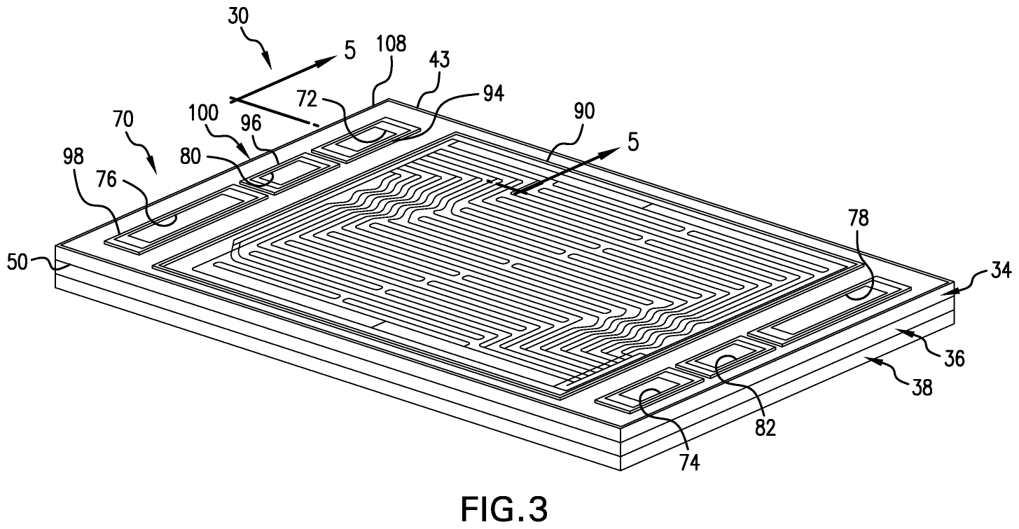

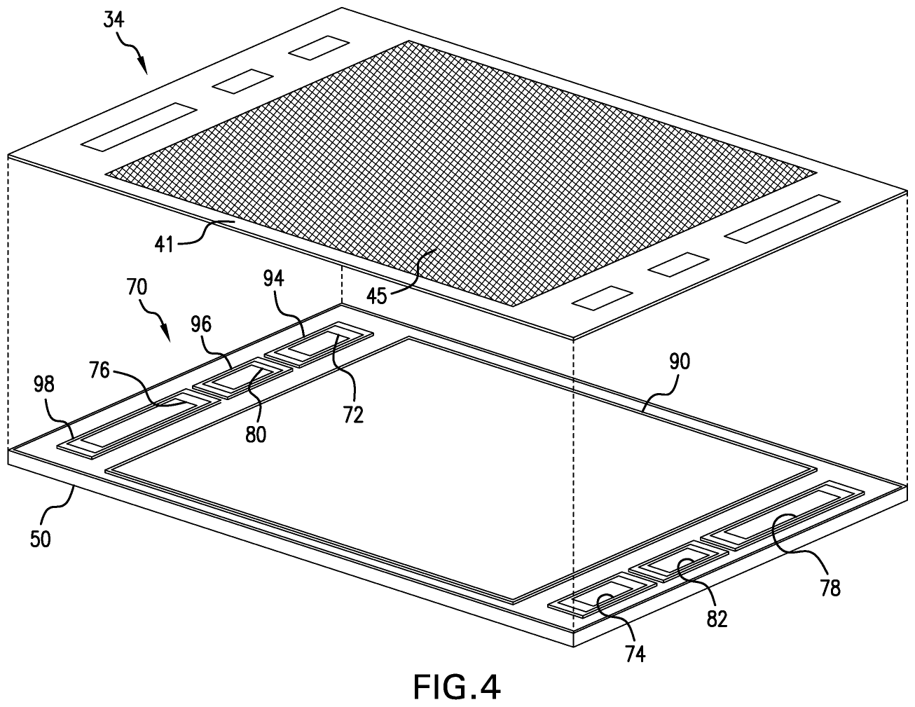

Reference will now follow to FIG. 3 in describing fuel cell system 30 in accordance with a non-limiting example. Fuel cell system 30 is formed from a plurality of stacked and interconnected bipolar plate assemblies including a first bipolar plate assembly 34, a second bipolar plate assembly 36, and a third bipolar plate assembly 38. The number and arrangement of bipolar plates may vary. Reference will follow to FIG. 4 and with continued reference to FIG. 3 in describing first bipolar plate assembly 34 with an understanding that second bipolar plate assembly 36 and third bipolar plate assembly 38 include similar structure.

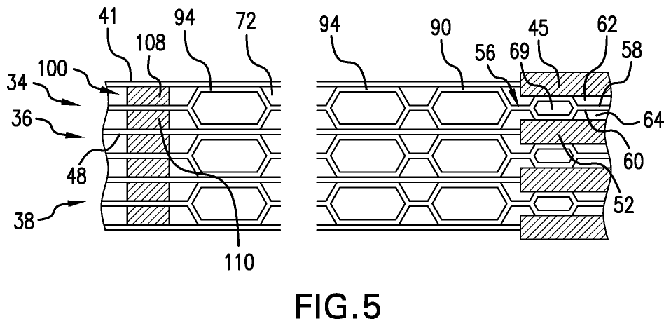

First bipolar plate assembly 34 includes a first subgasket 41 having a first peripheral edge 43 and a first membrane electrode assembly (MEA) 45. First bipolar plate assembly 34 also includes a second subgasket 48 having a second peripheral edge 50. Second subgasket 48 includes a second MEA 52. As shown in FIG. 5, second subgasket 48 may define a surface of second bipolar plate assembly 36, and also a surface of first bipolar plate assembly 34. A bipolar plate 56 is positioned between first subgasket 41 and second subgasket 48. Bipolar plate 56 includes a first side 58 that defines a cathode side (not separately labeled) and a second side 60 that defines an anode side (also not separately labeled).

In a non-limiting example, bipolar plate 56 may be formed from a metal. In another non-limiting example, bipolar plate 56 may be formed from a non-metal.

Bipolar plate 56 includes a plurality of corrugations (not separately labeled) that form a first plurality of passages 62 on first side 58. First plurality of passages 62 may contain a first reactant or cathode fluid (not shown) that would be in contact with a surface (not separately labeled) of first MEA 45. The corrugations also form a second plurality of passages 64 at second side 60. Second plurality of passages 64 may contain a second reactant or anode fluid (not shown) that is in contact with a surface (also not separately labeled) of second MEA 52. Bipolar plate 56 also includes a plurality of coolant passages 69 that may contain a coolant that absorbs heat from fuel cell system 30.

In further accordance with a non-limiting example, bipolar plate 56 includes a plurality of headers 70 that fluidically communicate with first plurality of passages 62, second plurality of passages 64, and coolant passages 69. More specifically, plurality of headers 70 include a first reactant inlet 72 and a first reactant outlet 74. Plurality of headers 70 also includes a second reactant inlet 76 and a second reactant outlet 78. Further, plurality of headers may include a coolant inlet 80 and a coolant outlet 82.

Bipolar plate 56 is further shown to include a perimeter seal bead 90 that extends entirely around first MEA 45, second MEA 52, as well as first plurality of passages 62, second plurality of passages 64, and coolant passages 69. Further each of the plurality of headers 70 includes an associated header seal bead such as shown at 94, 96, and 98 in connection with first reactant inlet 72, second reactant inlet 76 and coolant inlet 80. For example, seal bead 94 extends entirely about first reactant inlet 72, seal bead 96 extends entirely about coolant inlet 80, and seal bead 98 extends entirely about second reactant inlet 76. Seal beads 90, 94, 96, and 98 are disposed between first subgasket 41 and second subgasket 48. Seal bead 90 extends about first bipolar plate assembly 34. In this manner, seal bead 90 fluidically isolates bipolar plate assembly 34 from ambient. Seal beads 90, 94, 96, and 98 ensure fluid isolation between the first reactant, the second reactant, and coolant and/or ambient.

During a crash event, seal bead integrity may be compromised. A change of seal force during the crash event can be expressed as

ΔF_leading∝(αN m a)/L Equation 1; and

ΔF_trailing∝−(αN m a)/L Equation 2
where ΔF_leading is the change of seal force [N/mm] in the leading cells;
ΔF_trailing is the change of seal force [N/mm] in the trailing cells; N is the number of cell within the stack;
m is the mass per cell [g];
a is the peak acceleration during crash [mm/s²];
α is the mass fraction of the cell applying over the seal area; and
L is the total seal length.

In order to reduce the absolute values of ΔF_trailing and ΔF_leading, one can either reduce the product (αN m a) or increase L. However, the quantity, (αN m a), is typically a fixed value predetermined by the power and power density of fuel cell stack while increasing seal length L would increase the probability of seal defect which adversely increases the risk of leaks. Based on the understanding of seal behavior during a crash event, it is desirable to provide a fuel cell with an energy attenuating bumper to improve sealing integrity and crash resistance of fuel cell seal by having the same effect of increasing L without actually changing the dimensions and the design of fuel cell seal.

Therefore, in accordance with a non-limiting example, bipolar plate assembly 34 also includes a compliant energy attenuating bumper 100 that is designed to absorb acceleration forces so that seal beads 90, 94, 96, and 98 maintain sealing integrity during, for example, a crash event. In a non-limiting example, compliant energy attenuating bumper 100 may include a first compliant bumper element 108 that is arranged between first side 58 of bipolar plate 56 and first subgasket 41 and a second compliant bumper element 110 that is arranged between second side 60 of bipolar plate 56 second subgasket 48. First compliant bumper element 108 is aligned with second compliant bumper element 110 in bipolar plate assembly 34. In a non-limiting example, compliant energy attenuating bumper 100 may extend about a portion of an outer periphery of bipolar plate assembly 34. In another non-limiting example, compliant energy attenuating bumper 100 may extend about an entire periphery of bipolar plate assembly 34.

It should be further understood that while shown as being disposed outwardly of seal beads 90, 94, 96, and 98, the particular location of compliant energy attenuating bumper 100 may vary. For example, compliant energy attenuating bumper 100 could be disposed inwardly of seal bead 90, or between any one of seal beads 90, 94, 96, and 98. In a non-limiting example, compliant energy attenuating bumper 100 takes the form of a polymer pad that is compressed when forming fuel cell 40. That is, compliant energy attenuating bumper 100 is under a pre-load during operation of fuel cell 40 as will be detailed herein.

In a non-limiting example, seal beads 90, 94, 96, and 98 are formed from a first material having a first stiffness and compliant energy attenuating bumper 100 has a second stiffness that is distinct from the first stiffness. Stiffness should be understood to be defined as an amount of total vertically applied compressive force [N] per cell required for unit displacement [mm] of seal bead or energy attenuating bumper deformation per cell. In a non-limiting example, the second stiffness may be half that of the first stiffness and as much as ten (10) times greater than the first stiffness. In a non-limiting example, the second stiffness may be between one (1) and two (2) times greater than the first stiffness.

Further, it should be understood that first compliant bumper element 108 possesses a first stiffness and second compliant bumper element 110 possesses a second stiffness. In a non-limiting example, the first stiffness of first compliant bumper element 108 may match the second stiffness of second compliant bumper element 110. In another non-limiting example, the first stiffness of first compliant bumper element 108 may be different than the second stiffness of second compliant bumper element 110. Further, stiffnesses may vary depending on location within the fuel cell 40.

The amount of stiffness may determine to what extent compliant energy attenuating bumper 100 extends about first bipolar plate assembly 34. The greater the stiffness, the less the coverage at which compliant energy attenuating bumper 100 extends about first bipolar plate assembly 34. Compliant energy attenuating bumper 100 is designed and positioned to realize acceleration forces before seal beads 90, 94, 96, and 98. In this manner, compliant energy attenuating bumper 100 may deform, and deflect thereby absorbing those acceleration forces so as to protect seal beads 90, 94, 96, and 98 and ensure an overall integrity of fuel cell system 30. It should be understood that the compliant energy attenuating bumper 100 is designed such that it would be under a preload or compressive force before a crash event. The compressive force establishes an unloading force range that accommodates a decrease in seal force in trailing cells during a crash event and a loading force range that accommodates an increase of seal force in leading cells during the crash event.

It should be understood that, in accordance with a non-limiting example, seal beads 90, 94, 96, and 98 actually seal against first subgasket 41 and second subgasket 48 and prevent reactant egress. In contrast compliant energy attenuating bumper 100 exerting a force on first subgasket 41 and second subgasket 48 is not designed to perform a sealing function. Further, it should be understood, that compliant energy attenuating bumper 100 exerts a force on first subgasket 41 and second subgasket 48 both under normal operation and during a crash event.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A fuel cell system comprising:
a plurality of stacked bipolar plate assemblies, each of the plurality of stacked bipolar plate assemblies comprising:
a first subgasket including a first peripheral edge, the first subgasket supporting a first membrane electrode assembly (MEA);
a second subgasket including a second peripheral edge, the second subgasket supporting a second MEA;
a bipolar plate disposed between the first subgasket and the second subgasket, the bipolar plate having a first side defining a first plurality of passages receptive of a cathode fluid, a second side defining a second plurality of passages receptive of an anode fluid, and a plurality of coolant passages defined between the first subgasket and the second subgasket;
a seal bead extending around the bipolar plate, the seal bead sealing against the first subgasket and the second subgasket; and
a compliant energy attenuating bumper extending about the bipolar plate spaced from the seal bead.

2. The fuel cell system according to claim 1, wherein the compliant energy attenuating bumper includes a first compliant bumper element and a second compliant bumper element.

3. The fuel cell system according to claim 2, wherein the first compliant bumper element comprises a first polymer pad and the second compliant bumper element comprises a second polymer pad.

4. The fuel cell system according to claim 3, wherein the first compliant bumper element includes a first stiffness and the second compliant bumper element includes a second stiffness.

5. The fuel cell system according to claim 4, wherein the first stiffness of the first compliant bumper element matches the second stiffness of the second compliant bumper element.

6. The fuel cell system according to claim 1, wherein the seal bead includes a first stiffness and the compliant energy attenuating bumper includes a second stiffness that is distinct from the first stiffness.

7. The fuel cell system according to claim 6, wherein the second stiffness is between about one half that of the first stiffness and about 10 times greater than the first stiffness.

8. The fuel cell system according to claim 1, wherein the bipolar plate is formed from one of a metal and a non-metal.

9. A power system comprising:
an electric motor; and
a fuel cell system including a plurality of stacked bipolar plate assemblies, each of the plurality of stacked bipolar plate assemblies comprising:
a first subgasket including a first peripheral edge, the first subgasket supporting a first membrane electrode assembly (MEA);
a second subgasket including a second peripheral edge, the second subgasket supporting a second MEA;
a bipolar plate disposed between the first subgasket and the second subgasket, the bipolar plate having a first side defining a first plurality of passages receptive of a cathode fluid, a second side defining a second plurality of passages receptive of an anode fluid, and a plurality of coolant passages defined between the first subgasket and the second subgasket;
a seal bead extending around the bipolar plate, the seal bead sealing against the first subgasket and the second subgasket; and
a compliant energy attenuating bumper extending about the bipolar plate spaced from the seal bead.

10. The power system according to claim 9, wherein the compliant energy attenuating bumper includes a first compliant bumper element and a second compliant bumper element.

11. The power system according to claim 10, wherein the first compliant bumper element comprises a first polymer pad and the second compliant bumper element comprises a second polymer pad.

12. The power system according to claim 11, wherein the first compliant bumper element includes a first stiffness and the second compliant bumper element includes a second stiffness.

13. The power system according to claim 12, wherein the first stiffness of the first compliant bumper element matches the second stiffness of the second compliant bumper element.

14. The power system according to claim 9, wherein the seal bead includes a first stiffness and the compliant energy attenuating bumper includes a second stiffness that is distinct from the first stiffness.

15. A vehicle comprising:
a body; and
a power system arranged in the body, the power system comprising:
an electric motor; and
a fuel cell system including a plurality of stacked bipolar plate assemblies, each of the plurality of stacked bipolar plate assemblies comprising:
a first subgasket including a first peripheral edge, the first subgasket supporting a first membrane electrode assembly (MEA);
a second subgasket including a second peripheral edge, the second subgasket supporting a second MEA;
a bipolar plate disposed between the first subgasket and the second subgasket, the bipolar plate having a first side defining a first plurality of passages receptive of a cathode fluid, a second side defining a second plurality of passages receptive of an anode fluid, and a plurality of coolant passages defined between the first subgasket and the second subgasket;
a seal bead extending around the bipolar plate, the seal bead sealing against the first subgasket and the second subgasket; and
a compliant energy attenuating bumper extending about the bipolar plate spaced from the seal bead.

16. The vehicle according to claim 15, wherein the compliant energy attenuating bumper includes a first compliant bumper element and a second compliant bumper element.

17. The vehicle according to claim 16, wherein the first compliant bumper element comprises a first polymer pad and the second compliant bumper element comprises a second polymer pad.

18. The vehicle according to claim 17, wherein the first compliant bumper element includes a first stiffness and the second compliant bumper element includes a second stiffness.

19. The vehicle according to claim 18, wherein the first stiffness of the first compliant bumper element matches the second stiffness of the second compliant bumper element.

20. The vehicle according to claim 15, wherein the seal bead includes a first stiffness and the compliant energy attenuating bumper includes a second stiffness that is distinct from the first stiffness.
